(19) United States
(12) Patent Application Publication
(10) Pub. No.: US 2014/0332088 A1
(43) Pub. Date: Nov. 13, 2014

(54) METHOD AND APPARATUS FOR MONITORING A NETWORK OF CONDUITS

(71) Applicant: Yona SENESH, Adi (IL)

(72) Inventor: Yona Senesh, Adi (IL)

(21) Appl. No.: 14/358,547

(22) PCT Filed: Nov. 19, 2012
(86) PCT No.: PCT/IL2012/050464

§ 371 Date: May 15, 2014

(30) Foreign Application Priority Data
Nov. 21, 2011 (IL) 216497

(51) Int. Cl. E03B 7/07; E03B 7/04; E03B 1/04

(52) U.S. Cl. CPC E03B 7/075; E03B 1/04; E03B 7/04; E03B 7/078
USPC 137/14; 137/115.25

(57) ABSTRACT

Apparatus for a network of conduits distributing liquid that is coupled to a supply of liquid and to a network. At least one sensor is coupled in fluid communication with the network and derives a level of demand of liquid from the network. At least one valve is coupled in fluid communication with the supply of liquid and with the network to control the flow of liquid to the network. A control unit is coupled to the sensor and to the valve, to command operation of the valve, and in absence of demand of liquid, to maintain a reduced pressure of liquid in the network relative to the supply pressure. The apparatus has a reservoir that accumulates liquid and releases liquid in response to, respectively, a rise and a drop of pressure of liquid in the network, whereby reduction of pressure by release of liquid is avoided.

### CROSS-REFERENCE TO RELATED APPLICATIONS

This application is a National Phase of PCT Application No PCT/IL2012/050464, filed Nov. 19, 2012, which claims the benefit of Israel Application No. 216497, filed Nov. 19, 2011. The entire contents of those applications are hereby incorporated by reference.

### TECHNICAL FIELD

The present apparatus and method protect networks of conduits distributing liquid, and more particularly, prevent wear and shocks, detect, estimate and report leaks and their extent.

### BACKGROUND ART

The prevention of wear in drinking or industrial water network systems is disclosed in DE102006039701 to Otto Kamp. Wear prevention is based on maintaining a low pressure in the network when there is no consumption of liquid. However, to reduce a high pressure to a low pressure, water is dumped to the sewer.

### SUMMARY OF INVENTION

There is provided a method for monitoring a network (III) of conduits (18) conducting liquid for consumption by operation of at least one consumer (16) of liquid. The method operates an apparatus (I) which is disposed in liquid communication intermediate between a supply of liquid (II) and the network. The apparatus comprises a control unit (70) that is adapted to control the apparatus, to respond to instructions, and to detect a leak of liquid in the network.

The method provides a no-demand low pressure level (C) in the network when there is no consumption of liquid. The need is avoided of dumping liquid for reducing a higher pressure to the lower no-demand low pressure level, by use of a reservoir. The control unit (70) is provided with instructions to respond to a detected leak or liquid, to estimate an extent of the detected leak, to classify the detected leak into one of a plurality of types of leaks according to the estimated extent of the leak, and to responding to the type of detected leak.

There is provided an apparatus (I) adapted to monitor a network (III) of conduits (18) conducting liquid for consumption by operation of at least one consumer (16) of liquid, the apparatus being disposed in liquid communication intermediate between a supply of liquid (II) and the network. The apparatus comprises a control unit (70) adapted to respond to instructions and to detect a leak of liquid in the network. The apparatus further comprises at least one pressure reducer (50) adapted to maintain a no-demand low pressure level (C) in the network when there is no consumption of liquid, and at least one reservoir (60) adapted to reduce surges of pressure to the lower no-demand low pressure level, to avoid loss of liquid, and to prevent need to dump liquid to a sewer. In addition, the apparatus comprises at least one sensor (40) adapted to derive at least one hydraulic parameter of the liquid, and the apparatus is adapted to operate in association with the sensor to provide an estimate of the extent of the detected leak. The control unit (70) is adapted to classify the detected leak into one of a plurality of types of leaks according to the estimated extent of the leak, and to provide a response to the type of detected leak.

There is thus provided a method for reducing a pressure of a liquid supplied at a supply pressure (A) from a supply of liquid (II) to a network (III) of conduits distributing the liquid. The reduction of pressure takes place during periods of lack of demand of liquid from the network and is intended to reduce wear of the network. The method comprises providing at least one sensor (40) coupled in liquid communication with the network III and configured to derive a level of demand of liquid from the network. The method further comprises providing at least one valve (30) coupled in fluid communication with the supply of liquid II and with the network III and configured to control a flow of liquid to the network. Moreover, method comprises coupling a control unit (70) in electric communication with the at least one sensor 40 and with the at least one valve, and configuring the control unit to command operation of the at least one valve, and in absence of demand of liquid, to maintain a reduced no-demand level of pressure (C) of liquid in the network III relative to the inlet supply pressure A.

The method further comprises providing at least one reservoir (60), coupling the reservoir in fluid communication with the supply of liquid (II) and with the network, and operating the reservoir for accumulating liquid and releasing liquid in response to, respectively, a selected rise and a selected drop of pressure of liquid in the network. Moreover, the method calls for reducing sequential rises of pressure of liquid in the network relative to the pressure of the supplied liquid, and avoiding reduction of pressure by dumping of liquid to a sewer.

There is provided an apparatus (I) for a network (III) of conduits (18) distributing liquid, the apparatus being coupled in fluid communication with an upstream supply of liquid (II) having a supply pressure level (A) and downstream with the network. The apparatus comprises at least one sensor (40) coupled in fluid communication with the network and configured to derive a level of demand of liquid from the network, and

at least one valve (40) coupled in fluid communication with the supply of liquid and with the network and configured to control a flow of liquid to the network, and

a control unit (70) coupled in electric communication with the at least one sensor and with the at least one valve, and configured to command operation of the at least one valve, and in absence of demand of liquid, to maintain a reduced no-demand pressure level (C) of liquid in the network relative to the supply pressure, and

at least one reservoir (60) coupled in fluid communication with the supply of liquid and with the network and configured to accumulate liquid and to release liquid in response to, respectively, a selected rise and a selected drop of pressure of liquid in the network, whereby sequential rises of pressure of liquid in the network are reduced, and whereby reduction of pressure by release of liquid to a sewer (82) is avoided.

The control unit (70) is configured to control pressure of liquid in at least one conduit (18) to maintain the low consumption level of pressure (C) during lack demand of liquid by at least one consumer (16) of liquid, to prevent waste of liquid dumped to a sewer (82), and to alleviate pressure shocks at end of consumption of liquid by the consumer(s) of liquid by closure of the at least one valve which is disposed on a main conduit (10).

There is provided a method for reducing a pressure of a liquid supplied at a supply pressure (A) from a supply of liquid (II) to a network (III) of conduits (18) distributing the liquid, the reduction of pressure taking place during periods of lack of demand of liquid from the network. The method comprises

providing at least one sensor (40) coupled in fluid communication with the network and configured to derive a level of demand of liquid from the network,

providing at least one valve (30) coupled in fluid communication with the supply of liquid and with the network and configured to control a flow of liquid to the network, and

coupling a control unit (70) in electric communication with the at least one sensor and with the at least one valve, and configuring the control unit to command operation of the at least one valve, and in absence of demand of liquid, to maintain a reduced no-demand pressure level (C) in the network relative to the supply pressure.

The method further comprises coupling at least one reservoir (60) in fluid communication with the supply of liquid and with the network, the at least one reservoir accumulating liquid and releasing liquid in response to, respectively, a selected rise and a selected drop of pressure of liquid in the network, whereby sequential rises of pressure of liquid in the network is reduced relative to the pressure of the supplied liquid, and whereby reduction of pressure by release of liquid to sewer (82) is avoided.

Next, during lack of demand of liquid from the network, the pressure of the liquid in the network and in the reservoir is reduced to the no-demand pressure level (C) while flow of liquid through a main conduit (10) is stopped and a bypass conduit (20) allows flow of liquid therethrough, through a pressure reducer (50), past the reservoir and via the bypass conduit to the network.

Thereafter, during demand of fluid from the network, the momentary pressure in the network and in the reservoir decreases to a low threshold pressure level (D) which is lower by some 20% than the no-demand pressure level (C), which low threshold pressure level (D) is derived by the sensor (40) which provides signals to the control unit to prevent flow of liquid through the bypass conduit so as to trap the momentary decrease of pressure in the reservoir and thereafter, permit flow of liquid through the main conduit to allow incoming fluid at the supply pressure (A) to supply liquid to the network at a consumption pressure level (B), and

once consumption of liquid in the system ends, the momentary pressure in the network increases to a high a threshold pressure level higher by some 5% than the consumption pressure level (B) as detected by the sensor which signals to the control unit to close the main conduit and thereafter, to reopen bypass conduct, whereby the pressure in network is reduced to the no-demand level (C) when the pressurized liquid compresses the trapped air in the reservoir.

### TECHNICAL PROBLEM

Apparatus for the protection of wear in networks of conduits for the distribution of liquid reduce the higher supply pressure by dumping liquid to the sewer to maintain the liquid at a lower pressure during periods of lack of consumption of liquid. One problem to be solved is to prevent the wasteful dumping of liquid to reduce pressure. Other problems to be solved concern the attenuation of shocks of liquid in the network, the classification of leaks by type according to their extent or severity, the delivery to a user of an estimate of the rate of leak of liquid, and the ability to remotely command the flow of liquid in the network.

### SOLUTION TO PROBLEM

The solution to the wasteful dumping of water is provided by use of a method and an apparatus having a container configured to attenuate transients and shocks of pressure. The other problems are solved by the derivation of hydrodynamic parameters during the operation of the apparatus for use in association with a computer program software-driven control unit.

### ADVANTAGEOUS EFFECTS OF INVENTION

The apparatus provides a complete protection suite to the users of a network of conduits of fluid, and is applicable to the concept of preservation of resources, such as for example, for a “smart home”.

The method and the apparatus are operative to prevent shocks of liquid in the network of conduits, monitor and detect leaks in real time, analyze the extent and urgency of repair of detected leaks, reduces wear of the conduits and their appliances, and improves the quality and purity of water. Furthermore, the method and the apparatus provide real time information about the actual consumption of liquid, report discrepancies of operation, and allow a user to remotely control the consumption of liquid in the network. Moreover, there is provided a method for the efficient cleaning of a filter which filters the liquid supplied to the apparatus and to the network of conduits.

### BRIEF DESCRIPTION OF DRAWINGS

FIG. 1 is a schematic diagram of an embodiment,

FIG. 2 is a qualitative graph of levels of pressure vs. time, and

FIGS. 3 to 5 illustrate further embodiments.

### DESCRIPTION OF EMBODIMENTS

### Embodiment 100

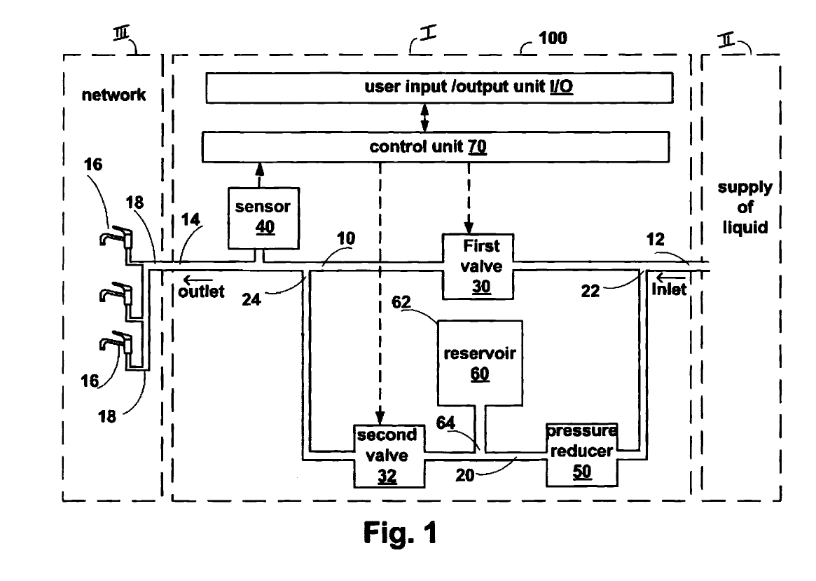

FIG. 1 depicts an apparatus I for disposition intermediate between a supply of liquid II at a supply pressure, and a network III having conduits 18 for the distribution of liquid to distributors 16, or consumers 16, or to liquid dispensing or consuming devices 16, which distributors are coupled to the network conduits 18. For example, the supply of liquid II may be a municipal supply of water, and the network III may be the plumbing system of a household that consumes water through consumers 16, such as taps 16. The network III is not limited to conduits of liquid of a household but may pertain for example, to conduits of liquid of an industrial facility. A network III is considered to have alt least one conduit 18 for the distribution of liquid and may have one or more consumers or distributors 16, such as taps, valves, appliances, and the like. The apparatus I may be used to retrofit existing networks III.

The apparatus I is configured to reduce the pressure of the liquid in the network III relative to the pressure of the supply of liquid II when the network III does not consume liquid. Reduced pressure reduces the loss of liquid in case of leakage and reduces wear of the conduits 18 of the network III. Furthermore, the apparatus I is configured to avoid and prevent shocks of pressure of liquid in the network III. Pressure shocks may result from suddenly ending the outflow of a large volume of liquid. Pressure shocks are less likely to occur in the plumbing system of a household, but may arise in the network III of a factory or an irrigation system for example, as well as in the supply of liquid II. The apparatus I is able to detect leaks, to categorize the leaks as leaks of different type, to estimate the volume or the rate of flow of a leak, and to report leaks to a user. A user, not shown, may communicate with and command the operation of the apparatus I.

For the sake of orientation, the apparatus I is coupled in liquid communication with and downstream of the supply of liquid II, and with and upstream of the network III.

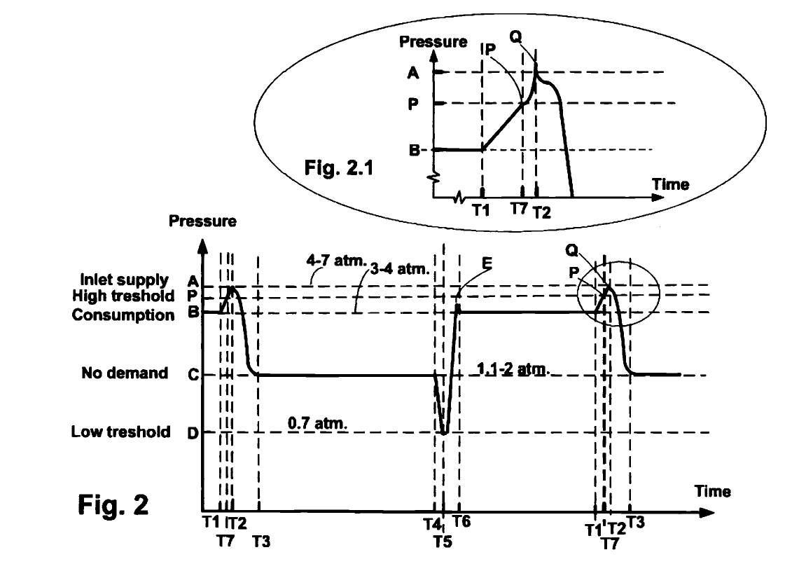

FIG. 1 shows a basic exemplary embodiment 100 of the apparatus I. The apparatus I is coupled in liquid communication with both the supply of liquid II and the network III. The supply of liquid II supplies liquid at a first supply pressure A, as shown in FIG. 2. For a household for example, the water inlet supply pressure A may vary between 3 to 7 atm (atmospheres) and is usually higher at night than during the day. In the description hereinbelow, pressure in atmospheres (atm) is not absolute but, is meant as being measured in addition to the atmospheric pressure.

The apparatus I has a first conduit 10, or main conduit 10, for conducting liquid therethrough, which conduit is coupled upstream by an inlet port 12 to the supply of liquid II, and downstream, by an outlet port 14 to the network III. The first conduit 10 thus stretches throughout the apparatus I, from the upstream inlet port 12 to the downstream outlet port 14. The apparatus I has a first bypass 20, which is a conduit of liquid that is coupled in liquid communication and in parallel to the main conduit 10. The first bypass 20 is coupled to the main conduit 10 upstream, at a first, bypass inlet 22, and downstream at a first bypass outlet 24. The first bypass inlet 22 is disposed downstream of the inlet port 12 and the first bypass outlet 24 is disposed upstream of the outlet port 14. It may be said that the main conduit 10 is a high-pressure conduit and that the first bypass 20 is mainly a low-pressure conduit.

A first valve 30, or main valve 30, is coupled in liquid communication with and on the main conduit 10 and is disposed downstream of the first bypass inlet 22 and upstream of the first bypass outlet 24. The first valve 30 has two ports and one downstream direction of flow, and may be selected out of many types ON/OFF valves, such as a membrane valve for example, but may preferably be selected as an electric or electromagnetic valve, operable by command of a control unit. This means that the first valve 30 will allow free downstream flow of liquid therethrough when disposed in the open ON state, and will prevent such a downstream flow of liquid when disposed in the closed OFF state. The first valve 30 may use commonly available channels of communication, wired or wireless, to receive valve opening and valve closure commands from a control unit 70. The first valve 30 thus controls the flow of liquid through the portion of the main conduit 10 downstream thereof.

A sensor 40 for sensing, deriving and measuring liquid flow parameters is coupled in liquid communication with the main conduit 10 and is disposed downstream of the first bypass outlet 24 and upstream of the outlet port 14. The sensor 40 may be selected as a pressure gauge, or as a liquid flow meter configured to derive hydraulic parameter readings in the form of liquid-derived signals. Furthermore, the sensor 40 may use various known methods of communication, wired or wireless, to communicate parameters derived from the liquid to a control unit 70, in the form of readable and storable signals. The sensor 40 thus monitors the flow of, liquid through the apparatus I and derives hydraulic parameters that may be reported, to, saved, stored, and processed by the control unit 70.

In FIG. 1, the sensor 40 is shown coupled to a control unit 70, which is coupled in bidirectional communication with an input/output unit IO.

Still in FIG. 1, a pressure reducer 50 is coupled in liquid communication to the first bypass 20 and is disposed downstream of the first bypass inlet 22 and upstream of the first bypass outlet 24. The pressure reducer 50 is configured to reduce the first supply pressure A, shown in FIG. 2, to a low pressure which may be set to say about 0.75 to 1.1 .atm, or if desired, to a low pressure set to about 20% of the no-demand pressure level C. At the end of the consumption of liquid, at time T3, the processor of the control unit 70 will compute and reset the low threshold level D. No-demand or lack of consumption of liquid signifies that the network III does not consume or require liquid, thus does not distribute liquid. The no-demand level of pressure C is maintained in the network III when there is no-demand of liquid. The pressure reducer 50 may be selected as a fixed-pressure reducer or as an adjustable pressure reducer of available type and able to meet requirements. The pressure reducer 50 is chosen to restrict and to maintain the flow of liquid at the no-demand pressure level C through the outlet port 14, even when there are small leaks in the network III. The apparatus I keeps the network III at a low no-demand level of pressure C such that in case of leaks in the network, the volume of the leaking liquid is reduced by the mere fact that the pressure of the liquid is relatively low.

A second valve 32, possibly similar to the first valve 30, is coupled in liquid communication with and on the first bypass 20 and is disposed downstream of the pressure reducer 50 and upstream of the first bypass outlet 24. The second valve 32, which may be referred to as the first bypass valve 32, may be selected as a bidirectional two-port ON/OFF valve allowing liquid to flow alternatively either downstream or upstream. The second valve 32 is coupled to the control unit 70 and is controlled thereby into either the open ON state or into the closed OFF state.

A reservoir 60 having a reservoir interior volume is coupled in liquid communication with and on the first bypass 20 and is disposed downstream of the pressure reducer 50 and upstream of the second valve 32. The reservoir 60 may be configured as a hollow body accommodated to contain a selected volume of liquid and of gas, such as for example, respectively, water and air trapped thereabove. The reservoir 60 has a reservoir body 62 terminating in a reservoir inlet 64 through which liquid may enter therein and exit thereout. The reservoir 60 is best disposed in a substantially vertical position oriented skywards above the first bypass 20. Due to the substantially vertical disposition of the reservoir 60, liquid penetrating therein will compress the trapped gas or air therein, which compressed gas or air will in turn bias the liquid. A rise of pressure of the incompressible liquid at the reservoir inlet 64 will force liquid into the reservoir 60 against the compressible gas trapped therein. Likewise, a drop of pressure of the liquid at the reservoir inlet 64 will release liquid therethrough and out of the reservoir 60.

If desired, the reservoir 60 may be selected as a hydraulic accumulator. For example, the reservoir 60 may be selected as a cylinder having therein a spring-loaded piston, or a flexible diaphragm, separating liquid from gas. Alternatively, the gas or the air may be confined to an expandable bag disposed in the cylinder. However, a plain hollow cylinder of defined volume is possibly a preferred solution in terms or simplicity and cost. For example, the body of a filter for filtering water in a conduit may possibly be used as the reservoir body 62 of the reservoir 60.

The volume of the reservoir 60 is preferably selected in accordance with the rate of flow of the liquid, or water, demanded by the network III from the supply of liquid II. It is noted that the response time of a reservoir 60 having an open reservoir inlet 64 to a transient surge of pressure for example, may be much faster than the time necessary to open and establish flow through a commonly used low cost ON/OFF valve. The reservoir 60 may be regarded as a fast response device for receiving and releasing liquid, for relief and equalization of pressure, of surges of pressure, and for the relief of energy. It may be advantageous for the reservoir inlet 64 to be larger by 50% relative to the size of the conduits 18 of the network III. Shocks due to abrupt transients of pressure of the liquid in the network III may be avoided and dampened by the reservoir 60, by rapid intake into and release of liquid out of the reservoir. The reservoir 60 is thus adapted to dampen transients of pressure and/or shocks of liquid, and to alleviate transients of high pressure to prevent dumping of liquid to the sewer, 82. The reservoir 60, which contains liquid and gas, operates as a hydraulic accumulator which is configured to equalize and attenuate fluctuations of pressure of the liquid, and to accumulate liquid to reduce pressure at the end of consumption of liquid. The reservoir 60 is thus adapted to dampen transients of pressure and/or shocks of liquid by entrance or ingestion of liquid therein and exit of liquid thereout. The reservoir 60 also releases liquid in response to the start of a consumption of liquid, and reduces sequential rises of pressure of liquid in the network III to avoid release of liquid to a sewer.

The reservoir 60 avoids the need of dumping water, thus wasting liquid in attempt to reduce a sudden rise of pressure of liquid, which is in contrast with German Patent Disclosure No. DE102006039701 to Otto Kamp, referred to hereinbelow as Kamp. Contrary to the resource saving ability of the reservoir 60, Kamp dumps water to a sewer drain to relieve pressure, thus unnecessarily wasting substantial amounts of water. Considering that in a household the liquid consumers 16 are typically operated about 200 times over a period of 24 hours, the resulting waste of water may amount to some one hundred liters, which is a cautious estimate.

Statistically, the daily demand of liquid in a household is restricted to about two hours, which means some 8% over a period of 24 hours. As a result, the conduits 18 are disposed at low level pressure for 92% of the time, for which time the apparatus I actually reduces both the wear of the conduits and the loss of water due to existing leaks. Furthermore, when there is no demand of liquid in the network III and the first valve 30 is closed, fluctuations of the supply pressure A as well as pressure shocks of liquid existing in the supply of liquid II will not cause damage to the conduits 18 and to the consumers 16 of the network III. Hence, from this last point of view too, the apparatus I reduces wear.

The control unit 70 manages and commands the operation of the apparatus I by deriving hydraulic parameters of the liquid and changes thereof, for example pressure and changes of pressure and by responding thereto by control of the flow of liquid, such as for example, by opening and closing valves. The control unit 70 may receive inputs from at least the first sensor 40, and may output operation commands to at least the first valve 30 and the second valve 32. The control unit 70 may include computer processing means such as a processor, a micro-controller or as a micro-computing unit, and a memory, which are not shown in the Figs. The memory is adapted for storing commands, data, and computer programs. The control unit 70 is configured to run at least one computer program stored in memory.

A user input/output unit IO, or I/O unit IO for short, is coupled by wired or wireless bidirectional communication to the control unit 70 for operation in association therewith, but the user is not shown in the Figs. The I/O unit IO may include elements not shown in the Figs., such as commonly available data input and output devices, as well as a transceiver for bidirectional wireless communication such as RF, Internet, and Wi-Fi. Data output devices and may include for example a display screen, a loudspeaker, light emitting devices or LEDs. The devices of the I/O unit IO are not shown in the Figs. A user may access the control unit 70 by operation of the I/O unit IO, or by remote control therewith via the transceiver. Output information may be provided to the user through the I/O unit IO via the transceiver. A cellular phone may be coupled to the control unit 70 as the, or one of the input and output device(s). The control unit 70 is thus provided with a bidirectional communication capability, and is linked to the input/output unit IO, which is adapted for remote bidirectional communication and operation in association with the control unit.

Power necessary for operating the control unit 70, the I/O unit IO, and the liquid control devices and/or valves coupled to the control unit may be provided from internal or external sources of electrical energy such as for example, respectively, a battery, and the electric mains. Alternatively, other power sources may be used, such as for example a rechargeable battery, photovoltaic cells coupled to a battery, or a generator. However, the power source is not shown in the FIGS.

In the embodiment 100 shown in FIG. 1, when there is no-demand of liquid from the network III, the first or main valve 30, which is disposed on the main conduit 10 is closed, and the second valve 32, or bypass valve 32, disposed on the first bypass 20, is open. Liquid at reduced pressure may flow from the supply of liquid II via the pressure reducer 50, past the reservoir inlet 64, and via the valve 32, such that liquid flows to the network III through the first bypass 20 to maintain low pressure therein, even in the presence of small leaks in the network. For consumption of liquid, the first valve 30 is open and liquid from the supply of liquid II flows through the conduit 10 to the network III.

### Operation of Embodiment 100

The operation of the embodiment 100 of the apparatus I is now described with respect to FIGS. 1 and 2. It is well known that systems and components usually do not operate at a level of 100% of precision, in particular not throughout the length of their lifetime of operation. Accordingly, with the embodiments of the apparatus I, a minimal threshold of flow of liquid is defined as a practical minimal leak of liquid for the various embodiments of the apparatus I, which minimal leak is accepted as representing a “no leak” condition. For practical purposes, there is no leak of liquid as long as the predetermined minimal threshold leak is not exceeded. Reference to a network condition without leaks of liquid is thus regarded as permitting a minimal leak of liquid having a value below the accepted threshold leak. Such a minimal threshold leak may be entered as a selected value in the control unit 70, either during manufacture or by a user taking advantage of an input device of the I/O unit IO. However, if desired, the minimal threshold leak may be set to zero, when a perfect “no-leak” condition is required in the network III.

FIG. 2 presents a qualitative illustration of the concept involving the elements forming the hydraulic mechanism and the operation of the apparatus I in response to a demand of, or end of demand of liquid from the network III. The simplified network III shown in FIG. 2 may have at least one consumer 16, or distributor 16, such as a single tap 16, which tap is restricted, for ease of description, to two states, namely an open state and a closed state. Pressure oscillations are not taken into consideration in FIG. 2 which is not to scale.

Hydraulic parameters of the liquid in the network III may be derived by the sensor 40 as pressures, or as pressure differentials, or as volumes of flow. Pressure measured by a pressure gauge is selected arbitrarily for the description hereinbelow and for the illustration of FIG. 2 which depicts an ordinate of pressure vs. an abscissa of time.

In FIG. 2, prior to the steady state of consumption of liquid by the network III, shown to last from time T6 to T1 at pressure level B, the apparatus I resides in a steady state of “no-demand-of-liquid” at pressure level C wherein the first valve 30 is closed and the second valve 32 is open. This means that the liquid supplied to the network III is kept at a no-demand level of pressure C that may range from 1.1 to 2 atm for example. Accordingly, pressure in the reservoir 60 is at the same no-demand level of pressure C. While there is no-demand of liquid, the processor of the control unit 70 computes the new low threshold pressure level D relative to the derived no-demand pressure level C. The new low threshold pressure level D will be lower by 20% relative to the actual no-demand level of pressure C, or be set to a constant pressure level of 0.7 atm.

A demand of liquid may be initiated by the opening of a consumer 16 of liquid coupled to a conduit 18 of the network III. A distributor 16 or a consumer 16 is, for example, a tap, or an appliance, or a toilet, or a valve, or another liquid consuming or distributing device. The demand of liquid may be detected by the sensor 40 as a change in a derived hydraulic parameter, such as for example, a drop of pressure of the liquid or an increased flow of liquid. The drop of pressure created in the network III by a sudden demand of liquid that starts at time T4, propagates to the bypass outlet 24 and through the second valve 32, and reaches the reservoir inlet 64, whereby liquid will exit out of the reservoir 60 to alleviate the drop of pressure.

When the sensor 40 detects a demand of liquid by deriving a pressure of liquid that reaches a low threshold D of say some 0.7 atm at time T5, the control unit 70 responds and commands sequential operation of first the second valve 32, and second, of the first valve 30. First in sequence, the control unit 70 commands the second valve 32 to the closed OFF state, thereby trapping liquid at low pressure in the reservoir 60. For the embodiments 100 to 300 inclusive, the pressure in the reservoir 60 may slowly rise from the low threshold level D to the reduced pressure delivered by the pressure reducer 50, and reach the low no-demand level of pressure C. Thereafter and second in sequence, the control unit 70 commands the first valve 30 to the open ON, state, which allows liquid from the supply of liquid II to flow unimpeded through the main conduit 10 and to the network III. Hence, liquid at pressure level of the first inlet pressure A emanating from the supply of liquid II, will flow via the first valve 30 and flow downstream of the sensor 40, and reach the network III at a demand or consumption pressure level B of say at 3-4 atm, and satisfy the demand, shown to last from time T6 till time T7, whereafter consumption is halted.

The short time span lasting between the time T4 and the time T6 lasts for a few seconds and represents the response of the apparatus I to the transition from the end of no-demand of liquid to the demand of liquid, respectively, from pressure level C to pressure level B.

This means that the drop of pressure to the low threshold D at time T5 is followed by a rapid rise of pressure between times T5 to T6, from pressure level D to pressure level B that may end as a peak pressure level E. After the transient of pressure peaking at pressure E, the pressure of the liquid stabilizes from time T6 td T1, to a consumption pressure level B, of about 3-4 atm for example. Following a demand of liquid starting at time T4, the apparatus I may perceive sudden transients of pressure, or fall-and-rise fluctuations of pressure of the liquid. Prior to the demand of liquid, the reservoir 60 contained liquid at a pressure lower than the no-demand level of pressure C, and at time T5, the reservoir 60 contains liquid at low threshold pressure level D. Therefore, the rise in pressure will be alleviated by the reservoir 60 which will ingest liquid to reduce of soften a shock of pressure. In parallel, to the main conduit 10, the first inlet pressure A of say at 4-7 atm also subsists at the first bypass inlet 22. Liquid will flow through the pressure reducer 50, such that liquid at a reduced pressure of say 0.8-1.1 atm will be supplied to the reservoir 60.

An end of consumption of liquid may occur upon closure of the distributors 16, assuming the absence of leaks of importance in the network III. In FIG. 2 at time T1 at the end of consumption of liquid, as best seen in FIG. 2.1, there may occur a momentary transient rise of pressure of liquid in the network III, up to and even above the inlet supply pressure level A, say up to a peak Q. However, when the high pressure of the liquid exceeds a predetermined high threshold pressure level P, which may be lower than the inlet supply pressure level A, the control unit 70 stops to the flow of supply of liquid II to the network III by closing the first valve 30.

With reference to FIGS. 2 and 2.1 and time T1 to time T2, it is noted that sometimes, when the consumption of liquid from the network III is very small, the difference between the demand pressure level B, the high threshold pressure level P, and the inlet supply pressure level A may be minimal. In such cases, the high threshold pressure level P may reach or almost reach the inlet supply level A.

Typically, at the end of the consumption of liquid, in response to the detection of the high threshold pressure level P at time T7, the control unit 70 first closes the first valve 30 to the closed OFF state, and thereafter, second in sequence, opens the second valve 32 to the open ON state. Upon closure of the first valve 30, the supply of liquid to the network III through the first conduit 10 comes to end. Liquid at a high level of pressure ranging between P and A is trapped in the network III, in the conduit stretching between the network III to the first valve 30, and in the conduit from the first bypass outlet 24 to the second valve 32.

Then, at time T2, the second valve 32 will be opened to the ON state and pressure will extend from the network III via the bypass outlet 24, and reach the reservoir inlet 64: Liquid at high pressure will be ingested by the reservoir 60 to ease and alleviate the high pressure and to prevent pressure shocks. Evidently, in the process for reducing pressure at the end of the demand of liquid, the need to dump liquid to the drain is prevented thanks to the pressure equalization operation of the reservoir 60, while avoiding or softening possible shocks pressure. The drop to the no-demand pressure level C that started at time T2 will gradually fall and level out at time T3 at the no-demand pressure level C, without need to waste liquid dumped to the sewer 82.

In the various embodiments 100 to 400, when there is flow in the main conduit 10, the reservoir 60 holds liquid at a pressure lower than the no-demand pressure level C ranging between 0.7 to 1.1 atm.

It is understood that the pressure levels indicated in FIG. 2 are not fixed absolute levels of pressure, but may vary within a range of values. For example, the pressure level A of the supply of liquid II, such as a municipal supply of water, may vary between say 4 to 6 atm, but is indicated as if being liquid at constant supply pressure A. Likewise, as derived by the first sensor 40, for a network III having a plurality of consumers 16, or distributors 16, the consumption pressure level B is higher when one flow-demanding distributor 16 is open, and lower when a plurality of distributors demand liquid. Hence, the consumption pressure level B may span over a range having a maximum lower than the first pressure of liquid supply A and a minimum that is higher than the no-demand pressure level C. However, such ranges or spans of pressure levels, as well as small oscillations of pressure of liquid are not shown in FIG. 2 for the sake of clarity. It is further noted that shock waves in the liquid will more likely occur when a demand for a large volume of liquid is suddenly stopped rapidly. Shock waves in the liquid are less likely to happen when one tap delivering a small volume of liquid is closed.

### Detection of Leaks in the Network

The detection of leaks in a network III is beneficial for a household, but may be of crucial importance to facilities running industrial processes. The various embodiments of the apparatus I described hereinbelow are configured to detect the existence of leaks of liquid in the network III. A leak may be defined as a monotonously continuous and uninterrupted flow of liquid past the first sensor 40 during a predetermined period of time, which flow of liquid or rate of flow exceeds a predetermined leak value and is not due in response to a demand of liquid by a consumer(s) 18. The predetermined leak value is selected according the specific network III to which the apparatus is coupled.

Leak detection is as a computer program driven process managed by the control unit 70 in association with a specific network III. The control unit 70 may be fed with data loaded a priori in memory and with data derived by the sensor(s) of the apparatus I to allow the computation of an estimate of the extent of the rate of leak of liquid at hand, thus the volume of lost liquid/time. Leaks may be classified into a plurality of types, such as at least small leaks and huge leaks, or as at least small leaks and large leaks, or as at least small, large and huge leaks, according to their extent and severity. The description hereinbelow will illustrate small, large, and huge types of leaks. One or more criteria and/or rules defining each one of those three types of leaks may be saved in the memory of the control unit 70 and may be preset in the apparatus I in factory, or be entered therein by a user operating one of the input devices of the I/O unit IO.

Following the detection of a leak, and possibly in response to the detected type of leak, a report is delivered to at least one responsible authority referred to hereinbelow, but not shown in the Figs., as a user, or as a supervisor in charge. Reports of leaks may increase in number, in intensity, and in spread of diffusion in proportion to their extent and seriousness, e.g. the number of users informed, the channels of transmission used, and the amount and sort of report signals delivered. Reports may be the same or be different for each type of leak but usually reports increase in number and in repetition in proportion to the extent of the reported leak. Such reports of leaks may be loaded in the memory of the control unit 70 or be entered therein by a user. The I/O unit IO may emit a report to a user, locally and/or remotely, as one or more acoustic, visual or sensory signal(s), which may be delivered by known channels of communication. For example, wired and wireless communication, such as telecommunication by RF, cellular phone networks, the Internet, and Wi-Fi, which may be received over devices such as cellular phones, personal computers, tablets, and other processor driven devices. In parallel, a user may respond to a received report over the same or different receiving devices and channels, by transmitting commands to the control unit 70 via the I/O unit IO. In addition, the at least one computer program operated by the control unit 70 may respond automatically to the detection of a leak following either the program or instructions stored a priori in the memory of the control unit, and/or by help of data derived before or during a leak test. The computer program may combine the various criteria and rules for application according to given predetermined stored precedence. This means that the control unit 70 may command to stop the supply of liquid to the network III, for example, when a leak is detected, estimate the extent of the detected leak, including estimating the rate of flow of the liquid in real time. It may also be said that the estimate of an extent of the detected leak of liquid comprises the delivery of an estimate of a rate of flow of the liquid and the delivery of a report to a user. In other words, a response to the type of the detected leak may include ending the supply of liquid to the network III and the delivery of a report to a user.

Leaks of liquid detectable by the various embodiments of the apparatus I may be classified for example into three types of leaks: a type 1 small leak, a type 2 considerable or large leak, and a type 3 catastrophic or huge leak. Leak tests may be operated periodically, continuously, or whenever so commanded by a user. For example, small leak tests are conducted periodically at time of no consumption of liquid, while tests for large and huge leaks may be performed during consumption, thus during demand of liquid.

Small leaks, which are difficult to detect, are regarded as outflows of liquid that exceed the allowed minimal threshold and are not expected to cause immediate damage. Small leaks may be detected by the embodiments of the apparatus I during periods of no-demand of liquid in the network III. Such small leaks may lose liquid at the rate of 6-8 liters per hour, and are usually not detected by common water meters. Small leak tests may be made say every twelve or twenty four hours, but for a household for example, preferably at night, when demand of liquid is not expected. Nevertheless, if so desired, a test for detecting a small leak may be performed whenever desired by the user, when there is no consumption of liquid, by operation of the I/O unit IO for entering a test start command to the control unit 70.

For a household for example, one criterion for a type 1 small leak may be defined as a leak having a rate of not more than one liter per week, or a few liters per day, but that criterion has to be selected according to the kind of network III and may be saved a priori in the memory of the control unit 70. It is the control unit 70 that provides an estimate of the volume or of the rate of flow of the liquid through the leak.

### Detection of Leaks in Embodiment 100

To check or test for a small leak, both the first valve 30 and the second valve 32 are kept closed for a small-leak-test-period-of-time of say some 5 to 15 minutes or longer if so desired. The small leak test period of time is dependent on the specific network III being tested and is stored a priori in the memory of the control unit 70. A monotonously continuing drop of pressure in the network III which is detected by the first sensor 40 indicates the existence of a small leak. The processor of the control unit 70 may run a computer program stored in memory to compute an estimate of the rate of loss of liquid, thus volume of liquid per unit of time, by use of parameters stored in advance in the memory of the control unit, such as the interior diameter of the conduit(s) 18, the length of the conduits, the type of conduits and the data derived by the first sensor 40 during the small leak test period of time. Although the repair of a small leak is not urgent, a report may be sent to a user such in the form of a simple notification, forwarded via at least one device out of the output devices of the I/O unit IO, or by some or all of the possible report signals described hereinabove if so desired.

When a consumer 16 of the network III demands a supply of liquid while a small leak test is ongoing, the test may be postponed for 15 to 60 minutes for example. The demand of liquid which is detected by the first sensor 40 as a drop of pressure is given precedence and is supplied first whereafter the small leak test is carried out in postponement. In the various embodiments of the apparatus I, the count of time is reset whenever the first sensor 40 detects a fluctuation of pressure whereby the flow of liquid departs from the monotonous behavior.

Large leaks that consume and waste large quantities of liquid may cause immediate damage and may need to be stopped immediately. Therefore, tests for large leaks are conducted continuously and in real time, as long as there is consumption of liquid by the consumers(s) 16 of the network III, to differentiate between a genuine demand of liquid and a large leak. When a large leak is detected, the supply of liquid has to be stopped and a report has to be delivered to the user, unless otherwise desired by the user.

Consumption of liquid starts when the first valve 30 is in the open ON state and the second valve 32 is in the closed OFF state, whereby the first sensor 40 derives a consumption pressure level B. At the start of consumption, the control unit 70 starts a clock, or time counter, not shown, for counting the total time of undisturbed continuous flow. That is, counting the total lapse of time during which the first sensor derives the same dynamic pressure. If there is an interruption of demand of liquid, or a change of the consumption pressure level B, the counter is reset and the clock resumes the count of time. If the total count of time clocked for the demand of liquid is shorter than the predetermined threshold of maximal time of consumption for the specific network III, then the demand of liquid was genuine and was not a large leak. Else, if the total count of time clocked for the demand of liquid exceeds the predetermined threshold of maximal time of consumption for the specific network III, then the demand of liquid is suspected being indicative of a large leak. It is understood that the maximal time of consumption of liquid may be defined by the user as in accordance with the type of the network III and of the use of the liquid, an may be loaded a priori in the memory of the control unit 70.

To make sure of the existence of a large leak, the extent of the actual leak is checked. The first valve 30 and the second valve 32 are both closed to the OFF state for a very short time of 0.2 to 0.3 sec. The control unit 70 may now compute an estimate of the rate of loss of liquid, thus volume of liquid per unit of time. The computation takes into consideration parameters stored a priori in the memory of the control unit 70, such as amongst others: the interior diameter, the length and the type of the conduit(s) 18, and data derived by the first sensor 40 such as the rate of drop of the pressure in the network III. The control unit 70 outputs at least a good estimate of the rate of leak of the lost liquid.

The repair of a large leak prone to cause serious damage may not be deferred as may be adequate for a small leak, but has to be reported to a user by at least one device out of the output devices of the I/O unit I/O. For example, one or more of the following reports may be sent alone and in combination: a message posted on a display, or sent via the Internet, or by Wi-Fi, or by cell phone, or as an alarm signal. The control unit 70 may be so programmed as not to respond to the large leak because sometimes in industry, the financial damage caused by the lack of supply of water to an ongoing process may be much more serious than the waste of water. Conversely, the control unit 70 may be so programmed that from the moment a large leak is detected, the first valve 30 and the second valve 32 will be commanded to close and to stop the supply of liquid to the network III. However, after receiving report of the extent of the leak and if so desired, the user may always be able reestablish the flow of water. Such an endeavor may be achieved by use of an input device out of the I/O unit I/O, to override and to reverse the automatic shutoff.

Huge leaks may sometimes cause irrecoverable losses besides the waste of enormous quantities of liquid, and need to be halted on the spot in most cases. Just as for large leaks, tests for huge leaks may be performed continuously, during consumption of liquid by the consumers(s) 16 of the network III.

A test for a huge leak is conducted from the very first moment there is a demand of liquid and whenever there is a change in the demand of liquid, i.e. a change of dynamic pressure as derived by the first sensor 40, the test for a large leak is restarted.

A demand of liquid, such as opening a consumer 16, causes a flow of liquid that is detected by the first sensor 40 as a drop of pressure. In turn, the control unit 70 is informed about the drop of pressure, and should the pressure of the liquid descend below the lower threshold D, the control unit will command the second valve 32 to close to the closed OFF state and open the first valve 30 to the open ON state Thereby liquid, which may be water, will flow through the main conduit 10 for consumption by the network III, at the consumption pressure level B, which is known for the specific network III and stored in memory a priori. If the pressure derived by the first sensor 40 is considerably lower than the minimal consumption pressure level B for the specific network III, thus close to the no-demand pressure level C, then one may suspect a huge leak. However, it may be possible that the low level of pressure derived by the first sensor 40 is due to a low inlet supply pressure A of the supply of liquid II.

To verify the existence of a huge leak, the process described hereinabove is repeated. The first valve 30 is closed to the OFF state for a short while, such as for 0.2 to 0.3 sec, while the first sensor 40 derives the drop of pressure and the control unit 70 computes the rate of drop of pressure in the network III. If the rate of drop of pressure is faster than a predetermined rate defined for the specific network III and stored in memory, then the leak may be accepted as being a huge leak. In that case, the first valve 30 and the second valve 32 are kept close, and a huge leak is reported to a user. The control unit 70 may derive an estimate of the rate of flow of the leak, which estimate is reported to a user as being a huge leak in the network III.

If the first valve 30 is closed for a very short time, say 0.3 sec, and the first sensor 40 derives a pressure higher than the previously derived low pressure, then there is no leak in the network III, but a momentary failure whereby liquid is supplied at low inlet supply pressure A by the supply of fluid II. Therefore, in the absence of a, leak, the first valve 30 may now be opened to the open ON state for supply of liquid to the network III.

A huge leak of water, which may become a potential danger to life and to the environment, must be urgently contained by closure of the first valve 30 and of the second valve 32. As described hereinabove, the control unit 70 may compute and report an estimate of the rate of loss of liquid. Report has to be emitted to more than one user by many output devices of the I/O unit IO as a plurality of alarm signals sent simultaneously over many communication channels. The control unit 70 may be so programmed as to automatically respond to a huge leak by closure of the supply of liquid to the network III. However, the alternatives described with reference to large leaks may be available too. If desired or necessary, the user may reestablish the flow of water even for a short while, by overriding the automatic shutoff by help of at least one input device of the I/O unit IO.

### Embodiment 200

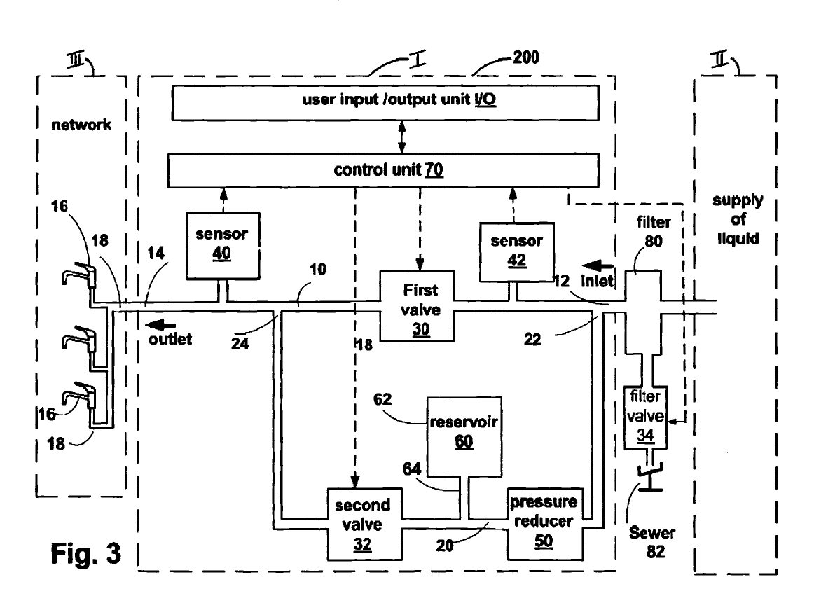

FIG. 3 illustrates an exemplary embodiment 200 of the apparatus I, similar in concept and in method of operation to the embodiment 100, showing the addition, relative to the embodiment 100, of a second sensor 42, of a filter 80, and of a filter valve 34.

The second sensor 42 may be identical to the sensor 40, and is disposed on and coupled in liquid communication with the main conduit 10. The second sensor 42 is disposed downstream of the inlet port 12 and upstream of the first valve 30. The second sensor 42 is coupled to the control unit 70 and may be used to derive the static pressure of the liquid delivered by the supply of liquid II to the apparatus I.

The filter 80 is coupled in liquid communication upstream with the supply of liquid II, and downstream with the main conduit 10, and is disposed upstream of the inlet port 12, and downstream of the supply of liquid II. A filter valve 34, possibly identical to the first valve 30, is coupled in liquid communication with the filter 80. The filter valve 34 is coupled to and commanded by the control unit 70 into either an open state or a closed state. The filter valve 34 is further coupled in liquid communication with a sewer drain outlet 82. Although FIG. 3 shows the filter 80 as if being disposed on the exterior of the apparatus I, the filter may be disposed in the interior of the apparatus. The same is true for the filter valve 34.

When the filter valve 34 is disposed in the closed state, liquid flows from the supply of liquid II through the filter 80 to the main conduit 10. The filter 80 thus filters and cleans the liquid supplied to the apparatus I and to the network III. However, when the filter valve 34 is disposed in the open state, liquid flows through the filter 80, purges and cleans the filter, and exits to the sewer drain outlet 82. The first valve 30 and the second valve 32 may be closed the OFF state while the filter 80 is purged.

The control unit 70 may automatically command a periodical or ad hoc cleaning procedure of the filter 80, and in addition, the user may command an immediate or delayed start of such a cleaning procedure whenever desired. Ad hoc cleaning of the filter 80 may be initiated when, with the filter valve 34 being disposed in the closed state, the second sensor 42 derives an unexpectedly low supply pressure reading A from the supply of liquid II. The control unit 70, which continuously records and saves readings of the supply pressure A in memory, may regard an out of range low supply pressure A following a continuous decline of pressure of the incoming liquid as an indication that the filter 80 is clogged. To check if the filter 80 is clogged, the control unit 70 may command closure of the first valve 30 and of the second valve 32 for say 0.1 sec, for the second sensor 42 to take a static pressure reading. The detection of a clogged filter 80 may trigger a filter cleaning procedure.

To achieve effective cleaning, the filter 80 may be purged through rapid successive cycles of cleaning shocks of random length of time. The first valve 30 and the second valve 32 may be closed the OFF state while the filter 80 is cleaned. The cleaning procedure of the filter 80 may include rapid successive closure and opening of the filter valve 34 during consecutive cycles of operation lasting for a random length of time to provide shocks of liquid that will best clean the filter 80. However, the filter cleaning procedure will be stopped if the second sensor 42 derives that there is no inlet supply pressure A.

Static pressure readings of the inlet pressure level A derived by the second sensor 42 may provide useful information regarding possibly anomalous pressure delivered by the supply of liquid II. For a household, the inlet pressure A delivered by the supply of liquid II may fluctuate between some four to six, or three to eight atmospheres. The second sensor 42 may derive static pressure readings of the inlet pressure A by rapid closure of the first and of the second valve, respectively 30 and 32, for a fraction of a second. Closure of both the first valve 30 and of the second valve 32 for say 0.1 to 0.3 sec will probably almost not be sensed by the network III, thereby allowing the second sensor 42 to periodically derive static pressure measurements.

For example, during supply of liquid to the network III, the first sensor 40 may derive readings of low dynamic pressure. Such low readings may result from either a large demand of liquid from the consumers 16, or a low delivery inlet pressure A.

To distinguish between both possibilities, a static pressure reading of the supply of liquid II may be derived by the second sensor 42. If the inlet pressure A is normal and within limits, then it is the network III that makes large demands of liquid. In the contrary, the filter 80 may be clogged.

Static pressure readings by the second sensor 42 may protect the network III from an exaggeratedly high inlet pressure A. Such protection may be achieved by, triggering the control unit 40 to command closure of the first valve 30 for as long as the static pressure exceeds predetermined limits, say as more than eight atm for a household.

### Operation of Embodiment 200

With reference to FIGS. 2 and 3, the operation of the embodiment 200 is similar to that of the embodiment 100 and does not require further description. It is noted that during periods of no demand of liquid from the network III, the second sensor 42 permits to derive the inlet pressure level A. The computer program operated by the processor of the control unit 70 may thereby more precisely compute and adjust the settings of the low threshold D and the high threshold P, shown in FIGS. 2 and 2.1.

### Embodiment 300

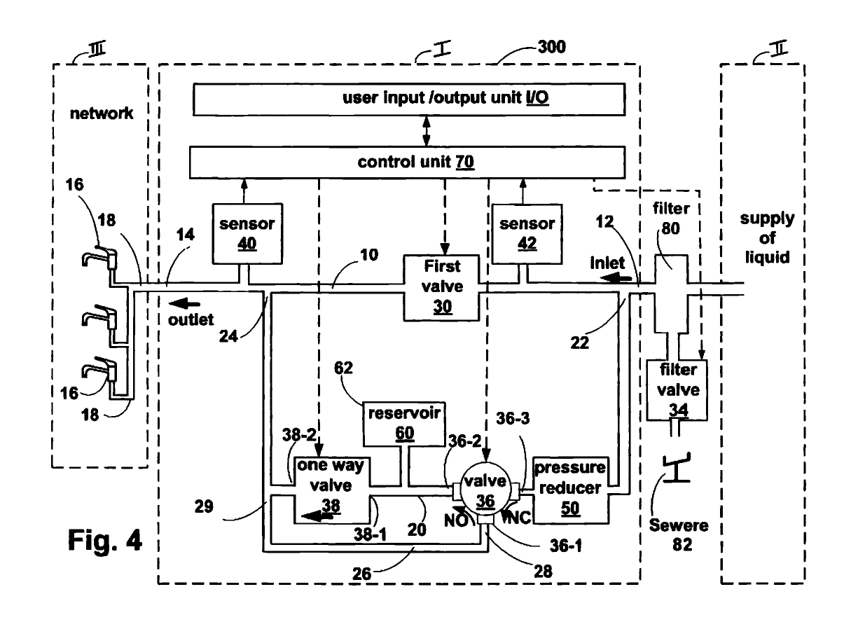

FIG. 4 depicts an exemplary embodiment 300 of the apparatus I, similar in concept and in method of operation to the embodiment 200 but relative thereto, featuring the addition of a second bypass 26, and of a first two ports one-way valve 38. Moreover, in the embodiment 300, the second valve 32 of the embodiment 200 has been removed and replaced by a third valve 36. The third valve 36 has three ports and may be disposed in two different states to allow flow of liquid along two different one-way paths.

The first one-way valve 38 is disposed on and in liquid communication with the first bypass 20 and allows downstream flow therethrough, from a port 38-1, which is disposed downstream of the reservoir 60, to a port 38-2 that is coupled upstream of the bypass outlet 24. Hence, the first one-way valve 38 allows downstream flow of liquid from the reservoir to the network III but prevents upstream flow of liquid from the network III to the first bypass 20 and into the reservoir 60.

The third valve 36 is coupled to and commanded by the control unit 70 and has, on the first bypass 20, a third upstream port 36-3 that is disposed downstream of the pressure reducer 50 and a second downstream port 36-2 which is disposed upstream of the reservoir 60. The first port 36-1 is coupled to the second bypass 26 which is disposed in parallel along a portion of the first bypass 20 and is coupled upstream to the third valve 36, and downstream, downstream of the one-way valve 38. The second bypass 26 joins the first bypass at a second bypass outlet 29. The third valve 36 is thus coupled in liquid communication with both the first bypass 20 and with the second bypass 26.

The third valve 36 may reside either in a first one-way normally closed NC state, or in a second one-way normally open NO state. In the closed NC state, liquid may flow through a first one-way path that runs from the third port 36-3 to the first port 36-1, whereby liquid may flow from the pressure reducer 50 through the third valve 36, then via the second bypass outlet 29 to the outlet port 14, and to the network III. The closed NC state of the third valve 36 prevents liquid at high pressure to flow from the main conduit 10 via the first bypass outlet 24 and the second bypass 26, through the third valve 36 and to the reservoir 60. In the open NO state, liquid at high pressure may flow from the main conduit 10 via the first bypass outlet 24 and the second bypass outlet 29 to the second bypass 26, through the third valve 36 and to the reservoir 60. In the open NO state, liquid at reduced pressure exiting out of the pressure reducer 50 is prevented to flow through the third valve 36 to the reservoir 60 and to the network III.

When there is no demand of liquid from the network III but the network III leaks, liquid at reduced pressure may flow from pressure reducer 50, via the closed NC state of the valve 36, and via second bypass 26 to the network III. The valve 36 is defined as a singular bypass valve where the open NO state enables pressure equalization between the pressure of the liquid in the network III and in the reservoir 60. However, the closed NC state of the third valve 36 and the first one-way valve 38 prevent liquid at high pressure from the network III to reach the reservoir 60, but allow reduced pressure from the pressure reducer 50 to reach the network.

Other elements of the embodiment 300 are similar to those of the embodiments 100 and 200 and are therefore not described again.

### Operation of Embodiment 300

Referring to FIGS. 2 and 4, it is first assumed that there is no-demand of liquid from the network III. Hence, liquid in the network III is at a no-demand level of pressure C of say 1.1-2 atm, as shown in FIG. 2 from time T3 to time T4. The first valve 30 is disposed in the closed OFF state and the third valve 36 is disposed in the closed NC state. Liquid from the supply of liquid II may enter the apparatus I, pass through the filter 80, to the inlet port 12, and next to the first bypass inlet 22, pass through the pressure reducer 50 and the valve 36, which is disposed in the closed NC state, to flow via the second bypass 26 to the network III.

As shown in FIG. 2, in response to a demand of liquid from a consumer 16, the pressure in the network III will momentarily drop to a low threshold level of pressure D, indicated as occurring at time T5. Thereupon, to attenuate the sudden drop of pressure of the liquid, the reservoir 60 will release liquid, pressure therein will drop, and the liquid will flow to the network III via the first one-way valve 38 and the first bypass outlet 24. The one-way valve 38 will allow a higher pressure of liquid contained in the reservoir 60 to alleviate a sudden dip of pressure of the liquid in the network III. In parallel, the first sensor 40 will transmit the derived drop of pressure to the control unit 70 which will first verify that the third valve 36 is disposed in the closed NC state, and will thereafter command the first valve 30 to the open ON state. Thereby, liquid incoming at liquid supply pressure A will flow from the supply of liquid II via the main conduit 10 through the first valve 30, past the sensor 40, and satisfy the demand of liquid in the network III.

Meanwhile, liquid at high pressure from the main conduit 10 will enter the first bypass outlet 24 and the second bypass 26. The liquid will be stopped from, flowing upstream into the first bypass 20 by the first one way valve 38, and out of the second bypass 26 by the third valve 36, which is disposed in the closed NC state. Thereby, the liquid at an instantaneous low pressure level D will remain trapped in the reservoir 60 since the passage of liquid at high pressure is to the reservoir 60 is blocked by both the one way valve 38 and the third valve 36.

In FIG. 2, the segment stretching from time T6 to T1 represents a steady flow of liquid at consumption pressure level B flowing into the network III. During demand of liquid at the consumption pressure level B, the processor of the control unit 70 computes a new value for the high threshold pressure level P, which new value is higher by 2-5% over the consumption pressure level B.

Closure of the consumer(s) 16 will end the demand of liquid from the network III. As shown in FIG. 2, the demand is stopped at time T1, causing a momentary rise and peak pressure as high as, for example, at least pressure level P, but which may peak at peak pressure level Q. However, when the high pressure of the liquid exceeds a predetermined high threshold, say of pressure level P, the control unit 70 commands, first in sequence, the first valve 30 to the closed OFF state, and thereafter, second in sequence, the third valve 36 to the open NO state.

When the first valve 30 turns to the closed OFF state, liquid at high pressure is trapped in the network III at time T7, as shown in FIG. 2. Thereafter, the third valve 36 turns to the open NO state. The high pressure of the liquid from the network III is relieved during time T2 to time T3, when liquid flows upstream via the first bypass outlet 24 to the second bypass 26, through the third valve 36 which is open in the NO state, and into the reservoir 60. As described hereinabove, the reservoir 60 alleviates, and operates to relieve the pressure of the trapped liquid during the transient fluctuations of pressure lasting for a short while from time T2 to time T3. Thereafter, the third valve 36 may be retuned to the closed NC state.

Following the reduction of pressure of the liquid that lasted from time T2 to time T3, the pressure of the liquid in the network III drops to the no-demand pressure level C of about 1.1 to 2 atm to prevent damage to the network such as wear for example. FIG. 2 shows an exemplary no-demand pressure level C lasting from time T3 to time T4.

The reservoir 60 is thus operative to stabilize transient pressures differentials of the liquid by ingestion therein and expulsion thereout of liquid to enhance rapid pressure equalization, and to prevent pressure shocks of liquid. Most important, ingestion of liquid in the reservoir 60 will reduce transients of high pressure or reduce surges of higher pressure and avoid the need to dump and waste liquid by release thereof to the sewer 82. In addition, the reservoir 60 is designed to dissipate energy accumulated in the network III.

### Detection of Leaks in the Embodiment 300

Small leaks are detected and dealt with in principle as described hereinabove with respect to the embodiment 100. To check or test for a small leak, the first valve 30 is closed to the closed OFF state and the third valve 36 is disposed in the open NO state. This means that flow of liquid through the apparatus I is stopped for a small-leak-test-period-of-time of say some 5 to 15 minutes, or longer if so desired. The small leak test period of time is dependent on the specific network III being tested and is stored a priori in the memory of the control unit 70. A monotonously continuing drop of pressure in the network III which is detected by the first sensor 40 indicates the presence of a small leak. The processor of control unit 70 may run a computer program stored in memory to compute an estimate of the rate of loss of liquid, thus volume of liquid per unit of time. The computation uses parameters stored in advance in the memory of the control unit 70, such as for example the interior diameter of the conduit(s) 18, the length of the conduits, and the data derived by the first sensor 40 during the small leak test period of time. Although the repair of a small leak is not urgent, a report may be sent to a user such in the form of a simple notification, forwarded via at least one device out of the output devices of the I/O unit I/O, or by some or all of the possible report signals described hereinabove if so desired.

When a consumer 16 of the network III demands a supply of liquid while a small leak test is ongoing, the test may be postponed for 15 to 60 minutes for example. The demand of liquid which is detected by the first sensor 40 as a drop of pressure is given precedence and is supplied first whereafter the small leak test is carried out in postponement. In the various embodiments of the apparatus I, the count of time is reset whenever the first sensor 40 detects a fluctuation of pressure whereby the flow of liquid departs from the monotonous behavior.

Large leaks are detected in principle as described hereinabove with respect with the embodiment 100. Tests for large leaks are conducted continuously and in real time, as long as there is consumption of liquid by the consumers(s) 16 of the network III, to differentiate between a genuine demand of liquid and a large leak. When a large leak is detected, the supply of liquid has to be stopped and a report has to be delivered to the user, unless otherwise desired by the user.

Consumption of liquid starts when the first valve 30 is disposed in the open ON state, and the third valve 36 is disposed in the closed NC state, whereby the first sensor 40 derives a consumption pressure level B. At the start of consumption, the control unit 70 starts a clock, or time counter, not shown, for counting the total time of undisturbed continuous flow. That is, the clock counts the total lapse of time during which the first sensor derives the same dynamic pressure. If there is an interruption of demand of liquid, or a change of the consumption pressure level B, the counter is reset and the clock resumes the count of time. If the total count of time clocked for the continuous demand of liquid is shorter than the predetermined threshold of maximal time of consumption for the specific network III, then the demand of liquid was genuine and was not a large leak. Else, if the total count of time clocked for the demand of liquid exceeded the predetermined threshold of maximal time of consumption for the specific network III, then the demand of liquid is suspected as being indicative of a large leak. It is understood that the maximal time of consumption of liquid may be defined as desired by the user, according to the type of network III and of the use of the liquid, and may be loaded a priori in the memory of the control unit 70.

To make sure of the existence of a large leak, flow through the apparatus I is stopped for a short while. This means that the first valve 30 is closed to the closed OFF state and the third valve 36 is disposed in the open NO state for a very short time of 0.2 to 0.3 sec. The processor of the control unit 70 may now run a computer program stored in memory to compute an estimate of the rate of loss of liquid, thus volume of liquid per unit of time. The computation takes into consideration parameters stored a priori in the memory of the control unit 70, such as amongst others: the interior diameter, the length and the type of the conduit(s) 18, and data derived by the first sensor 40 such as the rate of drop of the pressure in the network III. The type of conduit 18 may include pipes made of plastic or other material, which dilate under pressure of liquid, and pipes made of metal for which the interior diameter does not change under pressure. At the end of the test, the control unit 70 outputs an estimate of the rate of leak of the lost liquid.

If as a result of the prevention of flow of liquid through the apparatus I, the first sensor 40 does not derive a drop of pressure, this is an indication that the consumer(s) 16 do not demand liquid, thus that there is no consumption of liquid by the network III. However, during the consumption of water, and to prevent erroneous decisions, the test for a large leak may be repeated at a periodical rate of repetition.

The repair of a large leak prone to cause serious damage may not be deferred as may be adequate for a small leak, but has to be reported to a user by at least one device out of the output devices of the I/O unit I/O. For example, one or more of the following reports may be sent alone and in combination: a message posted on a display, or sent via the Internet, or by Wi-Fi, or by cell phone, or as an alarm signal. The control unit 70 may be so programmed as not to respond to the large leak because sometimes in industry, the financial damage caused by the lack of supply of water to an ongoing process may be much more serious than the waste of water. Conversely the control unit 70 may be so programmed that from the moment a large leak is detected, the first valve 30 and the second valve 32 will be commanded to close and to stop the supply of liquid to the network III. However, after receiving report of the extent of the leak and if so desired, the user may always be able reestablish the flow of water. Such an endeavor may be achieved by use of an input device out of the I/O unit I/O, to override and to reverse the automatic shutoff.

Huge leaks may sometimes cause irrecoverable losses besides the waste of enormous quantities of liquid, and need to be halted on the spot in most cases. Just as for large leaks, tests for huge leaks may be performed continuously, during consumption of liquid by the consumers(s) 16 of the network III.

A test for a huge leak is conducted from the very first moment there is a demand of liquid and whenever there is a change in the demand of liquid, i.e. a change of dynamic pressure as derived by the first sensor 40, the test for a large leak is restarted.

A demand of liquid, such as opening a consumer 16, causes a flow of liquid that is detected by the first sensor 40 as a drop of pressure. In turn, the control unit 70 is informed about the drop of pressure, and should the pressure of the liquid descend below the lower threshold D, the control unit will command the third valve 36 to the open ON state and open the first valve 30 to the open ON state. Thereby liquid, which may be water, will flow through the main conduit 10 for consumption by the network III, at the consumption pressure level B, which is known for the specific network III and stored in memory a priori. The inlet supply pressure A may be derived by the second sensor 42 when there is no demand of liquid from the network III. The inlet supply pressure A derived just before the demand of liquid may be compared to the consumption pressure level B for the specific network III, for which the boundaries of the consumption pressure level B relative to the inlet supply pressure A are known. If the pressure derived by the first sensor 40 is considerably lower than the minimal consumption pressure level B for the specific network III, thus close to the no-demand pressure level C, then one may suspect a huge leak. However, it may be possible that the low level of pressure derived by the first sensor 40 is due to a clogged filter 80.

To make sure of the existence of a huge leak, the process described hereinabove is repeated. The third valve 36 in disposed in the open NO state, and the first valve 30 is closed to the OFF state for a short while, such as for 0.2 to 0.3 sec, while the first sensor 40 derives the drop of pressure. The control unit 70 may now compute an estimate of the rate of loss of liquid, thus volume of liquid per unit of time. The computation takes into consideration parameters stored a priori in the memory of the control unit 70, such as amongst others: the interior diameter, the length and the type of the conduit(s) 18, and data derived by the first sensor 40 such as the rate of drop of the pressure in the network III. The control unit 70 outputs at least a good estimate of the rate of leak of the lost liquid.

If the rate of drop of pressure is faster than a predetermined rate of drop stored in memory for the specific network III, then the leak may be accepted as being a huge leak. In that case, flow of liquid through the apparatus I is stopped. This means that the first valve 30 is kept in the closed OFF state and the third valve 36 is kept in the open NO state. The control unit 70 may derive an estimate of the rate of flow of the leak, which estimate is included in the report of the presence of a huge leak in the network III that is delivered to the user.

If at the time of closure of the first valve 30 to the closed OFF state the rate of drop of the pressure as measured by the first sensor 40 is slower than the predetermined rate of drop stored in memory for the specific network III, then it is the filter 80 that is clogged. The first valve 30 may be opened to the open state to supply liquid to the network III, and at the end of consumption of liquid, the cleaning procedure of the filter 80 is initiated. If even after the cleaning procedure of the filter 80 the consumption pressure level B is still out of bounds, then the control unit 70 may report regarding the suspicion of a failure of the filter 80.

A huge leak of water, which may become a potential danger to life and to the environment, must be urgently contained by closure of the first valve 30 and of the second valve 32. As described hereinabove, the control unit 70 may compute and report an estimate of the rate of loss of liquid. Report has to be emitted to more than one user by many output devices of the I/O unit I/O as a plurality of alarm signals sent simultaneously over many communication channels. The control unit 70 may be so programmed as to automatically respond to a huge leak by closure of the supply of liquid to the network III. However, the alternatives described with reference to large leaks may be available too. If desired or necessary, the user may reestablish the flow of water even for a short while, by overriding the automatic shutoff by help of at least one input device of the I/O unit I/O.

### Embodiment 400

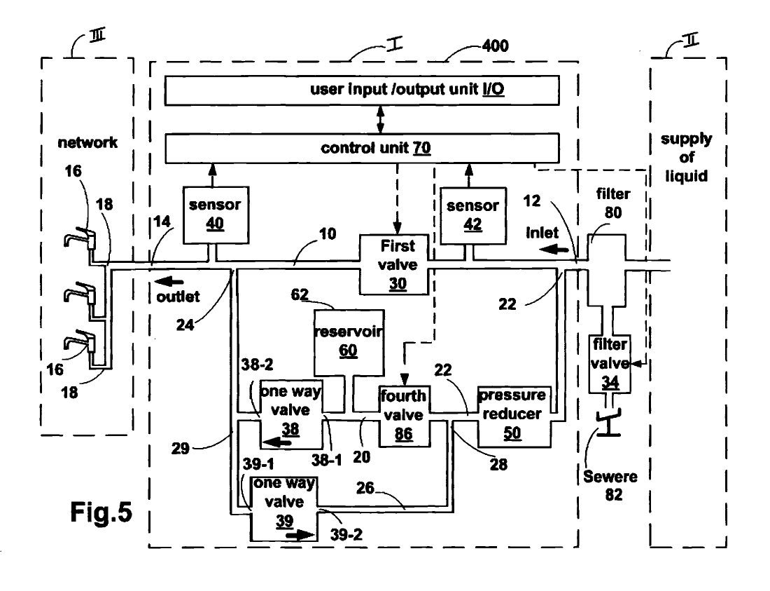

FIG. 5 depicts an exemplary embodiment 400 of the apparatus I, which is similar in concept and in method of operation to the embodiment 300. In the embodiment 400, relative to the embodiment 300, the third valve 36 is removed while a second one-way valve 39, and a fourth valve 86, are added. The description of the embodiment 400 is restricted to the differences over the embodiment 300 to keep the description simple.

The second one-way valve 39, which may be identical to the first one-way valve 38, is disposed on the second bypass 26 to allow upstream unidirectional flow so as to prevent the downstream flow of liquid in case of severe malfunction. In other words, second one-way valve 39 permits flow in a direction opposite to that of the first one-way valve 38. The second one-way valve 39 is coupled in liquid communication downstream of the second bypass inlet 28, which is coupled downstream of the pressure reducer 50, and upstream of the first bypass outlet 29.

The fourth two-port valve 86 is disposed in liquid communication with and on the first bypass 20, downstream of the second bypass inlet 28 and upstream of the reservoir 60. The fourth valve 86, which may be identical to the first valve 30, is coupled to and commanded by the control unit 70 into at least a first open ON state and a second closed OFF state.

When there is no-demand of liquid from the network III, the first valve 30 is disposed in the closed OFF state and the fourth valve 86 is disposed in the open ON state. When a small leak exists in the network III, liquid at low pressure may flow through the pressure reducer 50, via the open ON state of the fourth valve 86 and the first one-way valve 38, to the network III.

### Operation of Embodiment 400

With reference to FIGS. 2 and 5 and for the sake of illustration, it is assumed liquid flows through the apparatus I for consumption by the network III. This means that the control unit 70 has commanded the first valve 30 into the open ON state, and the fourth valve 86 into the closed OFF state.

To supply a demand of liquid from the network III, liquid flows via the main conduit 10 from the supply of liquid II through the first valve 30 and to the network, whereinto liquid may flow at a consumption pressure level B. The reservoir 60 disposed downstream of the fourth valve 86 and contains liquid at the low threshold pressure level D.

When the demand of liquid ends at time T1, the rise of pressure in the liquid to at least the high threshold level P may be derived by the first sensor 40 and be forwarded to the control unit 70. In turn, at time T7, the control unit 70 commands first, the first valve 30 to the closed OFF state, and thereafter, the fourth valve 86 to the open ON state at time T2, whereby the pressure of the liquid drops to the no-demand pressure level C, at time T3.

Liquid under pressure in the network III may pass via the first bypass outlet 24, through the upstream directed one-way valve 39, and through the second bypass 26 to the open third valve 86 and to the reservoir 60. The liquid under pressure will be ingested by the reservoir 60 which will attenuate the transient pressure fluctuation and equalize the pressure to reach, at time T3, a pressure ranging from 1.1 to 2 atm, which may be the no-demand pressure level C.

Upon demand of liquid, the first valve 30 is opened to the ON state, and the third valve 36 is disposed in the open NO state. The pressure of the liquid in the network III and in the reservoir 60 may drop from the pressure level C to the pressure level D between time T2 to time T3. The drop of pressure may be derived by the first sensor 40 and be forwarded to the control unit 70. To attenuate the drop of pressure, liquid exits out of the reservoir 60 and flows to the network III via the first one-way valve 38 and the first bypass outlet port 24.

The first one way valve 38 thus permits flow therethrough for the equalization of pressure when the network III is at a lower pressure and the reservoir 60 is at a higher pressure until the liquid in the reservoir reaches the low threshold pressure D.

In response to the demand of liquid, when the low threshold pressure level D is met at time T5, the control unit 70 commands first in sequence, the fourth valve 86 to the closed OFF state, and second in sequence, the first valve 30 to the open ON state. In the first sequence, closure of the fourth valve 86 traps liquid at low pressure, of say about the low threshold pressure level D, in the reservoir 60. The second sequence opens the first valve 30 to the open ON state, whereby liquid at consumption pressure level B may flow from the supply of liquid II through the length of the main conduit 10, via the first valve 30 and the first sensor 40, to supply the demand in the network III.

Furthermore, liquid at consumption pressure B also reaches the first one way valve 38, but passage therethrough is blocked by being contrary to the allowed direction of flow. Moreover, the same consumption liquid also flows through the one way valve 39 and through the second bypass inlet 28, and reaches the fourth valve 86, which by being closed to the OFF state, traps liquid at low pressure in the reservoir 60.

### Detection of Leaks in the Embodiment 400

Leaks are detected and dealt with in principle as described hereinabove with, respect to the embodiment 300. The difference is that with the embodiment 400 it is the fourth valve 86 that is operated instead of the third valve 36 of the embodiment 300. This means that with the embodiment 300, the third valve 36 is disposed in the open NO state to prevent flow downstream to the network III, whereas with the embodiment 400, the fourth valve 86 is closed to the OFF state to achieve the same effect. To allow flow downstream to the network III, the third valve 36 is disposed in the closed NC state with the embodiment 300, which corresponds to the open ON state for the fourth valve 86 of the embodiment 400

### INDUSTRIAL APPLICABILITY

The apparatus and method described hereinabove are applicable for production and for use by industry.

### REFERENCE SIGNS LIST

A liquid supply pressure
B consumption pressure level
C no-demand pressure level
D low threshold pressure level
P high threshold pressure level
Q peak pressure level
I/O user input/output unit
I apparatus
II supply of liquid II
III network III
10 main conduit 10
12 inlet port
14 outlet port
16 tap at network conduits
18 Distributor network
20 first bypass
22 first bypass inlet
24 bypass outlet
26 second bypass
28 second bypass inlet
29 second bypass outlet
30 first valve
32 second valve
34 filter valve
36 third valve; two-way tree-port valve
36-1 common inlet to third valve
36-2 outlet to conduit 20 from third valve
36-3 downstream to pressure reducer
38 first one-way valve or first check valve
38-1 inlet to first one-way valve
38-2 outlet to first one-way valve
39 second one-way valve or second check valve
39-1 inlet to second one-way valve
39-2 outlet to second one-way valve
40 first sensing means
42 second sensing means
50 pressure reducer
60 reservoir
62 reservoir body
64 reservoir inlet
70 control unit
80 filter
82 sewer drain outlet
84 intermediate conduit
86 fourth valve
100 first embodiment
200 second embodiment
300 third embodiment
400 fourth embodiment

1-21. (canceled)

22. Apparatus for distributing a liquid through a network of conduits, the apparatus being coupled in fluid communication with an upstream supply of liquid, said liquid being supplied at a supply pressure and said network of conduits being coupled with a downstream network of conduits, the apparatus further comprising:
a main conduit coupling the supply of fluid in fluid communication with the supply pressure and with the network of conduits, the main conduit being configured to provide liquid at a pressure equal at most to the supply pressure, said main conduit is adapted for flow of the liquid at a first pressure,
a bypass conduit coupled in fluid communication with the main conduit, the bypass conduit being configured to supply liquid to the network of conduits at a reduced pressure relative to the supply pressure, the bypass conduit is adapted for flow of the liquid at a second pressure, and
at least one sensing means coupled in fluid communication with the network of conduits,
at least one valve connected in fluid communication with the supply of liquid and with the network of conduits and said valve being configured to control a flow of liquid to and from the network of conduits,
a control unit coupled in electric communication with the at least one sensing means and with the at least one valve, and configured to control operation of the at least one valve, and in absence of demand of the liquid, to maintain a reduced pressure of the liquid in the network of conduits relative to the supply pressure, and
at least one reservoir coupled in fluid communication with the network of conduits and being configured to accumulate the liquid and to release the liquid in response to, respectively, a selected rise and a selected drop of pressure of the liquid in the network of conduits,

23. The apparatus of claim 1 wherein:
the at least one reservoir is configured as an hydraulic accumulator capable to ingest the liquid received from the network of conduits.

24. The apparatus of claim 1 wherein:
the reservoir being configured as a sealed cylinder having one reservoir inlet opening, which inlet is coupled in fluid communication with the bypass conduit, or, being configured as a hollow body accommodated to contain a selected volume of the liquid and of a gas or, being configured as a cylinder having a spring-loaded piston, or, being configured as a hollow container having a diaphragm separating liquid from the gas, wherein alternatively, the gas/air being confined in a bag disposed in the cylinder.

25. The apparatus of claim 1 further comprising:
at least one valve being configured to open and to close flow of the liquid through the main conduit and/or through the bypass conduit.

26. The apparatus of claim 1 wherein:
the network of conduits is selected from a group consisting of a household plumbing system, conduits of liquid of a building, conduits of liquid of a neighborhood, and conduits of liquid of an industrial facility.

27. The apparatus of claim 1 in which
the at least one sensing means is configured as a gauge, or as a sensor, or as a flow sensor means, said at least one sensing means being capable to function as a pressure reading means, or as a fluid flow meter, said at least one sensing means is configured to provide a fluid-derived signal to the control unit, said at least one sensing means is capable to detect minute variations of pressure or flow of the liquid,
said at least one sensing means is capable of sensing and measuring liquid flow parameters, said at least one sensing means is coupled in fluid communication with the main conduit and is disposed downstream of the bypass outlet and upstream of an outlet port.

28. The apparatus of claim 1 further comprising:
a first one-way valve which allows downstream flow of the liquid from the reservoir, to the network of conduits but prevents upstream flow of the liquid from the network of conduits to the bypass conduit and into the reservoir,
the reservoir allows to trap a momentary decrease of pressure, and
a pressure reducer means is in fluid communication with the supply of liquid and with the network of conduits to maintain low pressure in the network, when there are small leaks is detected in the network of conduits,
a first valve, or a main valve, which is coupled in fluid communication with the main conduit, and
a second valve which is coupled in fluid communication with the bypass conduit and is disposed upstream of the bypass conduit outlet and downstream of the pressure reducer.

29. A method for reducing a pressure of a liquid supplied at a supply pressure from a supply of liquid to a network of conduits, such that reduction of pressure taking place during periods of lack of demand of the liquid from the network of conduits without wasting the liquid, the method comprising the steps of:
providing at least one sensing means coupled in fluid communication with the network of conduits and configured to derive a level of demand of the liquid from the network of conduits,
providing at least one valve coupled in fluid communication with the supply of liquid and with the network of conduits and configured to control a flow of the liquid to the network of conduits,
coupling a control unit in electric communication with the at least one sensing means and with at least one valve, said control unit is configured to control operation of the at least one valve,
and in absence of demand of the liquid, to maintain a reduced pressure of the liquid in the network of conduits relative to the supply pressure, and said method comprising
coupling at least one reservoir in fluid communication with the network of conduits, for accumulating the liquid and releasing the liquid in response to, respectively, a selected rise and a selected drop of pressure of the liquid in the network of conduits, the at least one reservoir is configured to prevent waste of the liquid for pressure reducing purposes, and
whereby sequential rise of pressure of the liquid in the network of conduits is reduced relative to the pressure of the supplied liquid.

30. The method of claim 8, wherein the at least one reservoir is operable as a hydraulic accumulator configured to equalize and to attenuate fluctuations of pressure in the liquid, the at least one reservoir is adapted for ingesting the liquid received from the network of conduits, the reduction of pressure takes place during periods of lack of demand of the liquid from the network of conduits and
whereby a dumping of pressure by release of the liquid is avoided.

31. The method of claim 8 wherein:
the network of conduits is selected from a group consisting of a household plumbing system, conduits of liquid of a building, conduits of liquid of a neighborhood, and conduits of liquid of an industrial facility, said method is suitable for reducing supply pressure of the liquid in the network of conduits, during periods of lack of demand of the liquid from the network of conduits, without however wasting the liquid.

32. The method of claim 8 further comprising the steps of:
coupling a main conduit in fluid communication to the supply of fluid and to the network of conduits, the main conduit being configured to provide the liquid at a pressure equal at most to the supply pressure,
coupling a bypass conduit in fluid communication with the main conduit, and configuring the bypass conduit to provide the liquid to the network of conduits at a reduced pressure relative to the supply pressure, and
providing a first one-way valve which allows downstream flow of the liquid from the reservoir to the network of conduits, but prevents upstream flow of the liquid from the network of conduits to the bypass conduit and into the reservoir such that the liquid at an instantaneous low pressure level will remain trapped in the reservoir during demand of fluid, and
supplying the liquid at a reduced pressure to the network of conduits during periods of lack of demand of the liquid from the network of conduits while avoiding loss of the liquid.

33. The method of claim 11, further comprising the step of:
coupling a pressure reducing means in fluid communication with the bypass conduit, to maintain low pressure in the network of conduits
when the flow of the liquid through the main conduit is stopped and the flow of the liquid through the bypass conduit is open, such that the liquid at a low pressure will flow via the pressure reducing means to the network of conduits when a small leak is present.

34. A method for controlling flow of liquid supplied to a network of conduits from a supply pressure, said method comprising:
providing a main conduit and a bypass conduit, with the possibility to be in flow communication with the supply pressure and with the network of conduits,
closing the bypass conduit and supplying the liquid to the network of conduits at a pressure equal at most to the supply pressure, or closing the main conduit and opening the bypass conduit for reducing the pressure of the liquid relative to the supply pressure, whereby the reducing of the pressure is not associated with releasing the liquid to a sewer.
